(19) United States
(12) Patent Application Publication
(10) Pub. No.: US 2014/0278567 A1
(43) Pub. Date: Sep. 18, 2014

(54) DETERMINING REIMBURSEMENT AMOUNTS BASED ON REIMBURSEMENT MODELS

(71) Applicant: McKesson Financial Holdings, Hamilton (BM)

(72) Inventors: Michael Flanagan, Blue Bell, PA (US); Julian Klein, Blue Bell, PA (US); Vikram Anantha, Blue Bell, PA (US); Suresh Muppalla, Blue Bell, PA (US); Murali Karamchedu, Blue Bell, PA (US); Surya Suravarapu, Blue Bell, PA (US); Scott Edward Fraser, Blue Bell, PA (US)

(21) Appl. No.: 13/841,071

(22) Filed: Mar. 15, 2013

(51) Int. Cl. G06Q 50/22; G06Q 40/08

(52) U.S. Cl. CPC G06Q 50/22; G06Q 40/08
USPC 705/4

(57) ABSTRACT

System, methods, and computer-readable media for determining allowed reimbursement amounts for one or more healthcare services rendered by a healthcare provider to a patient are disclosed. The allowed reimbursement amount may be determined in accordance with reimbursement model parameter(s) and/or reimbursement rule(s) associated with a reimbursement model.

### FIELD OF THE DISCLOSURE

This disclosure relates generally to determining reimbursement amounts for healthcare services rendered by healthcare providers, and more particularly, to determining reimbursement amounts based on reimbursement models.

### BACKGROUND

Upon rendering a healthcare service to a patient, a healthcare provider typically generates a healthcare claim transaction that identifies the healthcare service rendered, the patient to whom the service was rendered, and potentially other identifying information. The healthcare provider then communicates the healthcare claim transaction—potentially via an intermediary entity—to a claims processor for adjudication. Adjudication of the healthcare claim transaction may involve a determination regarding the patient's eligibility for reimbursement, and if the patient is determined to be eligible, an allowed reimbursement amount for the healthcare service that was rendered. The healthcare provider that provides the healthcare service may be, for example, a physician or other healthcare personnel in a clinical, outpatient, or hospital setting; a pharmacist or other pharmacy employee; or the like. Healthcare claim transactions may also be generated in order to seek reimbursement for dispensed healthcare products.

A healthcare provider and a payor may negotiate one or more agreements (e.g., reimbursement fee schedules) that specify agreed-upon reimbursement amounts for various healthcare services that may be rendered by the healthcare provider. The negotiated fee schedules may differ for each healthcare insurance product offered or managed by the payor.

### BRIEF DESCRIPTION OF THE DRAWINGS

The detailed description is set forth through reference to the accompanying drawings. In the drawings, the left-most digit(s) of a reference numeral identifies the drawing in which the reference numeral first appears. The use of the same reference numerals indicates similar or identical items; however, similar or identical items may also be designated with different reference numerals. Various embodiments may utilize element(s) and/or component(s) other than those illustrated in the drawings, and some element(s) and/or component(s) may not be present in various embodiments. A description of a component or element using singular terminology may, depending on the context, encompass a plural number of such components or elements and vice versa.

FIG. 1 is a schematic block diagram depicting an illustrative reimbursement determination system for determining allowed reimbursement amounts in accordance with one or more embodiments of the disclosure.

FIG. 2 is a schematic block diagram depicting, in accordance with one or more embodiments of the disclosure, various illustrative hardware and software components of illustrative computing device(s) of the reimbursement determination system depicted in FIG. 1.

FIG. 3 is a schematic block diagram of an illustrative hierarchal relationship between insurance products associated with an illustrative reimbursement model in accordance with one or more embodiments of the disclosure.

FIG. 4 is a schematic block diagram of an illustrative reference hierarchal relationship between insurance products in accordance with one or more embodiments of the disclosure.

FIG. 5 is a process flow diagram of an illustrative method for determining an allowed reimbursement amount based on reimbursement model parameter(s) and reimbursement rule(s) associated with a reimbursement model in accordance with one or more embodiments of the disclosure.

FIG. 6 is a process flow diagram of an illustrative method for identifying a service group sub-hierarchy associated with an input insurance product and a corresponding reimbursement model in accordance with one or more embodiments of the disclosure.

FIG. 7 is a process flow diagram of an illustrative method for identifying a service group based on which model-based and/or rule-based processing may be performed to determine an allowed reimbursement amount in accordance with one or more embodiments of the disclosure.

### DETAILED DESCRIPTION OF EMBODIMENTS OF THE DISCLOSURE

### Overview

Embodiments of the disclosure relate to, among other things, systems, methods, computer-readable media, techniques, and methodologies for determining an allowed reimbursement amount for one or more healthcare services rendered by a healthcare provider to a patient. Model-based evaluation processing and/or rule-based evaluation processing may be performed based on a reimbursement model in order to determine the allowed reimbursement amount.

In one or more embodiments of the disclosure, a reimbursement determination system comprising one or more computing devices may be provided. The one or more computing devices may include any suitable processor-driven device. One or more program modules executable on the computing device(s) may support functionality for performing model-based and/or rule-based processing associated with a reimbursement model on any of a variety of types of input data in order to determine an allowed reimbursement amount for one or more rendered healthcare services. The terms “allowed reimbursement amount,” “final reimbursement amount,” “reimbursement amount,” “allowed amount,” and variations thereof may be used interchangeably herein.

In certain embodiments, the reimbursement determination system may be configured to identify an appropriate reimbursement model based on healthcare claim data received from one or more data sources. A reimbursement model may be associated with and/or representative of a financial arrangement established between a provider of healthcare services (or an entity acting on behalf of the healthcare provider) and a payor such as a private or public insurer. The reimbursement model may include, for example, a reimbursement fee schedule that specifies negotiated base reimbursement amounts for various healthcare services that may be provided by the healthcare provider. The reimbursement amounts specified in the reimbursement fee schedule may be based on any of a wide variety of parameters such as, for example, an insurance product held by the patient, types of healthcare services rendered, settings in which healthcare services are rendered, and so forth. As will be described in more detail hereinafter, the reimbursement model may further specify various service groups, where each service group is associated with one or more healthcare services and a respective insurance product included in the reimbursement model. In addition, various reimbursement model parameters may be associated with each service group that specify reimbursement terms and reimbursement tiers associated with healthcare services included in the service group. Further, as will be described in more detail hereinafter, various reimbursement rules may be associated with insurance products and/or service groups of which the reimbursement model is comprised.

The data source(s) from which the healthcare claim data may be received may include, for example, one or more payor systems, a system or platform that aggregates claim data, and so forth. The healthcare claim data may include data pertaining to one or more healthcare claims. Data relating to a particular healthcare claim may include, for example, data that identifies an insurance product offered by a payor and held by the patient, data that identifies one or more healthcare services rendered to the patient, other data associated with the patient and/or the healthcare provider, and so forth. As will be described in more detail hereinafter, a variety of other types of input data may also be received by the reimbursement determination system and may be utilized as part of a reimbursement amount determination. The healthcare claim data may represent a subset of the input data that may be received by the reimbursement determination system.

In certain embodiments, a single healthcare claim may include multiple “claim lines” with each claim line identifying a particular healthcare service (e.g., a procedure or operation) performed on the patient as well as, potentially, a procedure code associated with the healthcare service and/or date/time information indicating when the healthcare service was performed. In certain embodiments, multiple healthcare services (such as healthcare services performed in an inpatient hospital setting) may be bundled together and reimbursed in accordance with a case or grouped rate.

Upon receipt of the healthcare claim data identifying an insurance product held by a patient for whom healthcare service(s) have been rendered by a healthcare provider, a determination may be made as to whether an appropriate reimbursement model is available for determining a reimbursement amount for the rendered service(s). An insurance product held by a patient and identified in healthcare claim data received by the reimbursement determination system may hereinafter at times be referred to as an “input insurance product.” In certain embodiments, an identifier that identifies a particular reimbursement model may be received by the reimbursement determination system as at least a portion of the input data. The reimbursement model may be retrieved based on the associated identifier and a determination may be made, based on at least a portion of the healthcare claim data (e.g., the input insurance product), as to whether the reimbursement model is appropriate for determining allowed reimbursement amounts for a healthcare claim reimbursed in accordance with the input insurance product.

In those embodiments in which the reimbursement model associated with the received identifier is not suitable for determining the allowed reimbursement amount, an exception message may be generated. The exception message may include an error code that indicates a reason for the exception. For example, the exception message may include an error code that indicates that an appropriate reimbursement model is not available for evaluating reimbursement of the received healthcare claim. The exception message may be communicated to one or more external systems such as, for example, an error reporting system which may, in turn, communicate an indication of the exception to the healthcare provider. In certain other embodiments, if a reimbursement model associated with the received identifier is deemed unsuitable for reimbursement evaluation of the received healthcare claim, the reimbursement determination system may be configured to identify an alternate reimbursement model for reimbursement evaluation.

Upon determining that the input insurance product exists within the identified reimbursement model, a hierarchy of service groups associated with the input insurance product may be identified. Each service group in the hierarchy may correspond to a group of related healthcare services and associated reimbursement model parameter(s). The reimbursement model parameter(s) may include various pricing parameters for determining reimbursement amounts for various healthcare services included in the service group. The reimbursement model parameter(s) may include, for example, reimbursement term parameters that specify the manner in which various rendered healthcare services will be reimbursed (e.g., per diem, per test, per unit, per visit, percentage of billed charges, case rate, etc.); reimbursement type parameters that specify various reimbursement types associated with the healthcare services (e.g., fixed dollar amount, percentage of billed charges, case rate, etc.); reimbursement tier parameters that may specify various time periods over which particular reimbursement type parameters may be applicable; fee schedules that specify associations between healthcare services and base reimbursement amounts or percentages; and so forth.

Each service group may identify a set of potential healthcare services that may be rendered by the healthcare provider and which may be reimbursed in accordance with a particular insurance product. Each healthcare service identified in any particular service group may be associated with a respective reimbursement term parameter. For example, healthcare services associated with a patient's hospital stay may be associated with a reimbursement term parameter that specifies that the services should be reimbursed on a per diem basis. As another non-limiting example, healthcare services provided in an outpatient clinical setting may be associated with a reimbursement term parameter that specifies that such services should be reimbursed on a per visit basis.

In addition, each healthcare service identified in any particular service group may be associated with a respective reimbursement type parameter that specifies whether the reimbursement amount for the healthcare service is a fixed dollar amount, a percentage of the billed charges for the healthcare service, a case rate associated with healthcare services that are aggregated together for the purposes of reimbursement, and so forth. Moreover, as previously noted, each service group may include one or more reimbursement fee schedules, or the like, that identify base reimbursement amounts associated with the healthcare services. In certain embodiments, various healthcare services associated with a service group may be associated with a reimbursement tier parameter indicating reimbursement in accordance with a multi-tier reimbursement methodology. For example, healthcare services provided in connection with a patient's stay at an inpatient facility may be reimbursed at a fixed dollar amount on a per-diem basis. The per-diem fixed reimbursement amount may be different for different periods of the stay. As a non-limiting example, healthcare services rendered during days 1-3 of a 10 day hospital stay may be reimbursed at a per-diem fixed amount of $100 while healthcare services rendered during days 4-10 of the stay may be reimbursed at a lesser per-diem amount of $50. It should be appreciated that the above examples are merely illustrative and that any suitable combination of reimbursement model parameters may be utilized to determine reimbursement amounts for rendered healthcare services.

Upon identification of the service group hierarchy, the hierarchy may be analyzed to identify a particular service group that may be utilized for determining the reimbursement amount for one or more healthcare services identified in a healthcare claim. One or more criteria associated with a healthcare service or a group of healthcare services for which reimbursement is sought may be identified, and a service group satisfying at least one of the one or more criteria may be identified. In certain embodiments, different service groups may be utilized for determining the reimbursement amounts for different healthcare services. For example, healthcare services rendered in a facility inpatient setting (e.g., a hospital setting) may be reimbursed in accordance with a particular service group while healthcare services rendered in a facility outpatient setting or a professional ancillary setting (e.g., a physician's clinic) may be reimbursed in accordance with an alternate service group.

As a non-limiting example, the service group hierarchy may be represented as a data structure (e.g., a tree), and the data structure may be traversed until a suitable service group is identified or until a determination can be made that the service group hierarchy does not include a suitable service group. In the event that no service group within the service group hierarchy is determined to satisfy established criteria, a determination may be made that the reimbursement model does not include a suitable service group for determining an allowed reimbursement amount. On the other hand, if a suitable service group is identified, model-based evaluation processing may be performed based on one or more reimbursement model parameters associated with the identified service group.

The model-based evaluation processing may generate a first interim reimbursement amount for one or more healthcare services. Rules-based processing may then be performed to determine a second interim reimbursement amount from the first interim reimbursement amount. The rules-based processing may include applying one or more reimbursement rules to the first interim reimbursement amount based on input data received by the reimbursement determination system. More specifically, various input data such as healthcare claim data, demographic data associated with the patient and/or the healthcare provider, data associated with a provider network that the healthcare provider is part of, and so forth, may be analyzed to determine if respective predicate conditions of one or more reimbursement rules are satisfied. For each respective predicate condition that is determined to be satisfied, an associated adjustment function may be applied to the first interim reimbursement amount to generate a second interim reimbursement amount. In various embodiments, the adjustment function may correspond to a specified percentage of the first interim reimbursement amount. In certain embodiments, if the respective predicate conditions of multiple reimbursement rules are satisfied, the first interim reimbursement amount may be repeatedly adjusted to generate the second reimbursement amount. In certain other embodiments, a weighted combination of various adjustment functions associated with satisfied predicate conditions, or a similar aggregating function, may be utilized to generate the second reimbursement amount.

In certain embodiments, upon determination of the second reimbursement amount, payment recommendations data received by the reimbursement determination system may be analyzed to determine whether the second reimbursement amount should be adjusted. The payment recommendations data may be received from any suitable data source. The payment recommendations data may specify a recommended reimbursement amount or a recommended adjustment to a reimbursement amount determined by the reimbursement determination system. The payment recommendations data may be generated based on independent reimbursement evaluation processing performed by, for example, a payor system. In certain embodiments, the payment recommendations data may be used to adjust the second interim reimbursement amount in order to determine a final reimbursement amount. In certain other embodiments, a recommended reimbursement amount indicated by the payment recommendations data may be utilized in lieu of the second interim reimbursement amount. In yet other embodiments, the payment recommendations data may not be utilized to adjust the second reimbursement amount, and the second reimbursement amount may correspond to the final allowed reimbursement amount for one or more healthcare services associated with a healthcare claim.

Upon determination of a final reimbursement amount, reimbursement information may be communicated by the reimbursement determination system to one or more other systems such as, for example, a payor system, a system for aggregating claim data and associated determined reimbursement amounts, a system associated with a healthcare provider, and so forth. The reimbursement information may include an indication of the final determined reimbursement amount as well as, potentially, audit information associated with the reimbursement determining processing. The audit information may include, for example, information identifying various inputs and/or determined values utilized by the reimbursement determination system to arrive at the final reimbursement amount such as, for example, interim reimbursement rates, input data, a reimbursement mode, reimbursement model parameters, reimbursement rules, and so forth. In addition, at least a portion of the reimbursement information may be presented to a user of the reimbursement determination system. Moreover, information may be communicated to and/or received as input from a user of the reimbursement determination system at any stage in the reimbursement determination processing.

It should be appreciated that the above-described model-based and rule-based processing may be repeatedly performed in order to determine each of one or more reimbursement amounts for one or more healthcare services associated with one or more healthcare claims. It should further be appreciated that any examples described above are merely illustrative and that numerous other examples, variations, modifications, and alternatives are within the scope of this disclosure.

For example, in one or more alternative embodiments of the disclosure, one or both of the first interim reimbursement amount and the second interim reimbursement amount may be determined by one or more systems external to the reimbursement determination system and may be communicated to the reimbursement determination system for use in determining a final reimbursement amount. Illustrative examples of such external systems include a payor-hosted system, a provider-hosted system, other reimbursement systems that service any of a variety of payment systems, or the like. In certain embodiments, external system(s) may be configured to perform processing based on a variety of types of data (e.g., data relating to quality or performance metrics associated with healthcare providers, data relating to performance incentives and/or disincentives negotiated between payors and healthcare providers, etc.) in order to generate information that may be received and utilized by the reimbursement determination system to determine, modify or validate an interim reimbursement rate generated as part of the reimbursement determination processing described herein for determining a final reimbursement amount.

The above description of the disclosure is merely illustrative and numerous other embodiments are within the scope of this disclosure. The embodiments described above as well as additional embodiments within the scope of this disclosure will be described in greater detail below.

### Illustrative Architecture

FIG. 1 is a schematic block diagram depicting an illustrative reimbursement determination system 102 for determining allowed reimbursement amounts in accordance with one or more embodiments of the disclosure. FIG. 2 is a schematic block diagram depicting, in accordance with one or more embodiments of the disclosure, various illustrative hardware and software components of illustrative computing device(s) of the reimbursement determination system depicted in FIG. 1. FIGS. 1 and 2 will be described hereinafter in conjunction with one another.

Referring to FIGS. 1 and 2, the reimbursement determination system 102 may include one or more reimbursement determination computer(s) 200. The reimbursement determination computer(s) 200 may include any suitable processor-driven device including, but not limited to, a server computer, a desktop computer, a laptop computer, a mainframe computer, a workstation, a mobile computing device, and so forth. The reimbursement determination computer(s) 200 may include one or more processors (processor(s)) 202, one or more memory devices 204 (generically referred to herein as memory 204), data storage 220, one or more input/output (“I/O”) interface(s) 222, and/or one or more network interface(s) 224.

The memory 204 may store computer-executable instructions that are loadable and executable by the processor(s) 202, as well as data manipulated and/or generated by the processor(s) 202 during the execution of the computer-executable instructions. For example, the memory 204 may store one or more operating systems (O/S) 206; one or more database management systems (DBMS) 208; a reimbursement determination application 210 comprising one or more program modules; and/or various types of data. The program modules may include computer-executable instructions that responsive to execution by the processor(s) 202 cause various processing to be performed. In order to perform such processing, the program modules may utilize, at least in part, data stored in the memory 204, data stored in the data storage 220, and/or data stored in one or more datastores 226.

The memory 204 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 204 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

Still referring to FIGS. 1 and 2, the program modules that may form part of the reimbursement determination application 210 may include a product hierarchy traversal module 104, a service group hierarchy traversal module 108, a model based evaluation module 112, a rules based evaluation module 116, and a payment recommendations evaluation module 120. The respective functionality supported by each of these program modules will be described in more detail hereinafter. It should be appreciated that the program modules depicted in FIGS. 1 and 2 are merely illustrative and that, in certain embodiments, a lesser number or a greater number of modules than those depicted may be provided. It should further be appreciated that, in certain embodiments, functionality supported by one or more of the program modules may be distributed across different reimbursement determination computers 200 or other computing devices. For example, certain of the program modules may only be provided and executable on certain reimbursement determination computer(s) 200. In addition, while the various program modules are depicted as forming part of the reimbursement determination application 210, in various embodiments, one or more of the program modules may be executable independently of the reimbursement determination application 210.

The memory 204 may further store data associated with one or more reimbursement models 212 and data associated with reimbursement model parameter(s) 214 and/or reimbursement rule(s) 216 associated with the reimbursement model(s) 212. In addition, the memory 204 may store any of a variety of other types of input data 218 which will be described in more detail later in this disclosure through reference to FIG. 1. It should be appreciated that any data stored in the memory 204 (e.g., data associated with reimbursement model(s) 212, other input data 218, etc.) may additionally, or alternatively, be stored in the data storage 220 and/or the datastore(s) 226. The DBMS 208 loaded into the memory 204 may support functionality for accessing, retrieving, storing, and/or manipulating data stored in the datastore(s) 226, the memory 204, and/or the data storage 220. The DBMS 208 may use any of a variety of database models (e.g., relational model, object model, etc.) and may support any of a variety of query languages.

The (O/S) 206 loaded into the memory 204 may provide an interface between other application software executing on the reimbursement determination computer(s) 200 and the hardware resources of the reimbursement determination computer(s) 200. More specifically, the O/S 206 may include a set of computer-executable instructions for managing hardware resources of the reimbursement determination computer(s) 200 and for providing common services to other application programs (e.g., managing memory allocation among various application programs). The O/S 204 may include any operating system now known or which may be developed in the future including, but not limited to, any desktop or laptop operating system, any server operating system, any mainframe operating system, any mobile operating system, or any other proprietary or freely available operating system.

As previously noted, the reimbursement determination computer(s) 200 may further include data storage 220 such as removable storage and/or non-removable storage including, but not limited to, magnetic storage, optical disk storage, and/or tape storage. Data storage 220 may provide non-transient storage of computer-executable instructions and other data. The data storage 220 may include storage that is internal and/or external to the reimbursement determination computer(s) 200. The memory 204 and/or the data storage 220, removable and/or non-removable, are examples of computer-readable storage media (CRSM) as that term is used herein.

The processor(s) 202 may be configured to access the memory 204 and execute computer-executable instructions stored therein. For example, the processor(s) 202 may be configured to execute computer-executable instructions of the various program modules of the reimbursement determination application 210 to cause or facilitate various operations to be performed in accordance with one or more embodiments of the disclosure. The processor(s) 202 may include any suitable processing unit capable of accepting digital data as input, processing the input data in accordance with stored computer-executable instructions, and generating output data. The processor(s) 202 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

As previously noted, the reimbursement determination computer(s) 200 may further include one or more I/O interfaces 222 that may facilitate the receipt of input information by the reimbursement determination computer(s) 200 from one or more I/O devices as well as the output of information from the reimbursement determination computer(s) 200 to the one or more I/O devices. The I/O devices may include, for example, one or more user interface devices that facilitate interaction between a user and the reimbursement determination computer(s) 200 including, but not limited to, a display, a keypad, a pointing device, a control panel, a touch screen display, a remote control device, a microphone, a speaker, and so forth. As a non-limiting example, the one or more I/O interfaces 222 may facilitate interaction between a user and the reimbursement determination computer(s) 200 to facilitate the creation and identification of reimbursement models and reimbursement amount determination processing based on the reimbursement models.

The reimbursement determination system 102 (or more specifically one or more of the reimbursement determination computer(s) 200) may be configured to communicate with any of a variety of other systems, platforms, devices, and so forth via one or more networks (not shown). As previously noted, the reimbursement determination computer(s) 200 may include one or more network interfaces 224 that may facilitate communication between the reimbursement determination computer(s) 200 and any of the above-mentioned systems, platforms or device via the network(s). The network(s) may include, but are not limited to, any one or a combination of different types of suitable communications networks, such as cable networks, packet-switched networks (e.g., the Internet), circuit-switched networks, wireless networks, cellular networks, or any other private and/or public networks. Further, the network(s) may include any type of medium over which network traffic may be transmitted including, but not limited to, coaxial cable, twisted-pair wire, optical fiber, hybrid fiber coaxial (HFC), microwave terrestrial transceivers, radio frequency communication mediums, or satellite communication mediums. As a non-limiting example, the reimbursement determination computer(s) 200 may be configured to communicate over the above-mentioned network(s) with one or more payor systems, a platform for aggregating healthcare claim data, one or more healthcare provider systems, one or more external systems from which information may be received for determining, modifying or validating one or more reimbursement amounts (e.g., interim reimbursement amounts).

It should be appreciated that the reimbursement determination computer(s) 200 are merely illustrative components of the reimbursement determination system 102. The system 102 may include any number of other components such as, for example, networking components (e.g., gateways, switches, routers, etc.), other datastore(s), and so forth. It should be further appreciated that the various hardware and software components depicted in FIG. 2 are merely illustrative, and the reimbursement determination computer(s) 200 may include a greater number, a fewer number, and/or different components than those depicted.

Referring again to FIG. 1, in one or more embodiments of the disclosure, the reimbursement determination system 102 may be configured to identify an appropriate reimbursement model for determining one or more reimbursement amounts for one or more healthcare services rendered to one or more patients. As previously noted, a reimbursement model may be associated with and/or representative of a financial arrangement established between a provider of healthcare services (or an entity acting on behalf of the healthcare provider) and a payor such as a private or public insurer, and may include, for example, a reimbursement fee schedule that specifies negotiated base reimbursement amounts for various healthcare services that may be provided by the healthcare provider. The reimbursement model may further include various service groups, where each service group is associated with a respective insurance product included in the reimbursement model. Each service group may include a set of one or more healthcare services that may be provided by a healthcare provider and various reimbursement model parameters may be associated with each service group that specify reimbursement terms, reimbursement types, and/or reimbursement tiers associated with healthcare services included in the service group. In addition, various reimbursement rules may be associated with insurance products and/or service groups included in the reimbursement model.

As depicted in FIG. 1, various types of data may be received as input data by the reimbursement determination system 102. One or more of the program modules 104, 108, 112, 116, and 120 may utilize at least a portion of the input data as part of processing performed in connection with determinations of one or more reimbursement amounts. The input data may be received from any of a variety of data source(s) including, but not limited to, one or more payor systems, a system or platform that aggregates claim data, one or more external reimbursement determination systems, and so forth.

Upon receipt by the reimbursement determination system 102, the input data may be stored in one or more datastores (e.g., the datastore(s) 226). It should be noted that while embodiments of the disclosure may be described hereinafter in the context of receipt of healthcare claim data and associated input data relating to a single healthcare claim identifying one or more healthcare services provided to a patient by a healthcare provider, input data relating to multiple healthcare claims, and potentially identifying healthcare services provided by multiple healthcare providers to patients insured under different insurance products, may be received by the reimbursement determination system 102. Accordingly, the illustrative processing described herein may be applied as part of any number of reimbursement amount determinations in connection with any of a variety of different reimbursement models.

Referring to FIG. 1, illustrative types of input data may include, for example, reimbursement model data 124. The reimbursement model data 124 may include data that identifies a reimbursement model for use in determining reimbursement amounts for one or more healthcare services rendered by a healthcare provider to a patient. The reimbursement model data 124 may include, for example, a reimbursement model identifier that identifies a particular reimbursement model. The reimbursement determination system 102 may be configured to identify and access the reimbursement model identified by the reimbursement model data 124 based on the associated identifier. In certain embodiments, the reimbursement model may be defined by a user. For example, a user may specify various insurance products to be included in the reimbursement model, various service groups associated with the insurance products, various reimbursement model parameters for use in determining interim reimbursement amounts for healthcare services forming part of the service groups, various reimbursement rules for further refining interim reimbursement amounts determined based on reimbursement model parameters, and so forth.

The input data received by the reimbursement determination system 102 may further include various forms of healthcare claim data. The healthcare claim data may include, for example, insurance product data 126 that identifies an insurance product offered by an insurer (or other payor) and which is held by the patient, and in accordance with which the healthcare service(s) rendered to the patient and identified in the received healthcare claim are to be reimbursed. As will be described in more detail hereinafter, the insurance product may be identified from the insurance product data 126 and processing may be performed to determine whether the insurance product is represented in the reimbursement model identified in the reimbursement model data 124. In certain embodiments, the insurance product identified in the insurance product data 126 may be determined by a payor system and that determination may be provided to the reimbursement determination system 102 as part of the insurance product data 126. In other embodiments, the insurance product may be determined by an intermediary system communicatively coupled to a payor system and the reimbursement determination system 102.

The healthcare claim data received by the reimbursement determination system 102 may additionally include billed healthcare services data 128 that identifies charges that have been billed by the healthcare provider for the healthcare service(s) rendered to the patient. For example, the healthcare claim data may identify a healthcare claim that identifies one or more healthcare services rendered to a patient and billed charges associated with the healthcare services. In certain embodiments, a billed charge may be relevant to a determination of the reimbursement amount for a particular healthcare service or group of healthcare services. For example, reimbursement model parameter(s) may specify that the reimbursement amount should be a certain percentage of the billed charge for a particular healthcare service or group of services.

The healthcare claim data received by the reimbursement determination system 102 may further include other healthcare claim data 130. The other healthcare claim data 130 may include any data associated with the healthcare claim including, but not limited to, identifying information associated with the patient; information indicating special circumstances associated with the rendering of any of the healthcare services identified in the healthcare claim such as, for example, information indicating a severity or complexity of a patient's condition; information associated with the healthcare provider such as, for example, information indicating a quality of healthcare services rendered by the healthcare provider, information indicating whether the healthcare provider is in compliance with guidelines or operating standards, and so forth; and/or any of a variety of other types of healthcare claim data 130 that may have an impact on the determined reimbursement amounts. In one or more embodiments, reimbursement model parameter(s) and/or reimbursement rule(s) associated with a service group in the reimbursement model used to determine a reimbursement amount for one or more healthcare services may specify that at least a portion of the other healthcare claim data 130 should be used to determine the reimbursement amount.

As a non-limiting example, if the other healthcare claim data 130 indicates that the healthcare provider is meeting or exceeding clinical guidelines or standards, reimbursement amounts for healthcare services rendered by the healthcare provider may be correspondingly increased as an incentive to the healthcare provider such as, for example, by a predetermined dollar amount or a predetermined percentage. Conversely, if the other healthcare claim data 130 indicates that the healthcare provider is not meeting established clinical guidelines or standards, reimbursement amounts for services rendered by the healthcare provider may be correspondingly decreased. As another non-limiting example, the other healthcare claim data 130 may be utilized to determine whether the patient may be insured or covered under another insurance product other than the one identified in the insurance product data 126, in which case, evaluation of the reimbursement amount may instead be performed in connection with the alternate insurance product which may, in turn, be associated with a different reimbursement model. It should be appreciated that the above examples are merely illustrative and that any of a variety of types of other healthcare claim data 130 may affect reimbursement amount determinations in any number of ways.

The input data received by the reimbursement determination system 102 may further include a variety of other types of data 132. The data 132 may include, for example, data associated with the healthcare provider that includes one or more metrics for assessing a quality of healthcare services provided by the healthcare provider. The data 132 may further include, for example, data identifying one or more negotiated reimbursement incentives or disincentives provided for in a contract or fee schedule negotiated between the healthcare provider and a payor or other entity acting on behalf of the payor. In addition, the data 132 may further include data that identifies a provider network and various geographical or other restrictions associated with the provider network and/or healthcare services that may be rendered by healthcare providers forming part of the provider network. For example, the data 132 may include demographic data relating to disease trends, disease prevalence, etc. within various populations. Still further, the data 132 may include data associated with one or more insured members such as, for example, data identifying member disease conditions or the like. Similar to the other healthcare claim data 130, the data 132 may be assessed to determine whether reimbursement amounts should be accordingly adjusted. As a non-limiting example, the data 132 may indicate that a patient insured under a particular insurance product received healthcare services that are eligible for reimbursement under an alternate, more appropriate insurance product. Accordingly, the reimbursement determination system 102 may determine that reimbursement amount evaluation should be performed based on a reimbursement model associated with the alternate product, which may be different from the reimbursement model initially identified in the reimbursement model data 124. The various types of input data (e.g., other healthcare claim data 130, data 132, etc.) that may further influence reimbursement amount determinations may be, in various embodiments, used to generate corresponding reimbursement model parameter(s) and/or reimbursement rule(s) that may be assessed as part of model-based evaluation processing and/or rules-based processing in accordance with one or more embodiments of the disclosure.

The input data received by the reimbursement determination system 102 may further include payment recommendations data 134 that may specify a recommended reimbursement amount for one or more healthcare services or a recommended adjustment to a reimbursement amount determined for healthcare service(s) by the reimbursement determination system 102. As will be described in more detail hereinafter, the payment recommendations data 134 may be analyzed to determine whether an interim reimbursement amount determined as part of the reimbursement amount evaluation processing performed by the reimbursement determination system 102 should be modified or adjusted or whether the recommended reimbursement amount identified in the payment recommendations data 134 should be utilized in lieu of the reimbursement amount determined by the reimbursement determination system 102.

Still referring to FIGS. 1 and 2, as part of the reimbursement evaluation processing disclosed herein, the product hierarchy traversal module 104 may include computer-executable instructions executable by the processor(s) 202 to receive as input the insurance product identified in the insurance product data 126 and analyze a reimbursement model identified based on the reimbursement model data 124 to determine whether the input insurance product exists within the reimbursement model. The various insurance products forming part of the reimbursement model may be organized into a data structure capable of being traversed upon execution of computer-executable instructions provided as part of the product hierarchy traversal module 104. As a non-limiting example, the insurance products in the reimbursement model may be organized into a hierarchal data structure (e.g., a tree) with each insurance product corresponding to a node in the data structure. The data structure may be traversed to attempt to locate the input insurance product. If the input insurance product is not locatable in the reimbursement model, it may be determined that the model is not appropriate for determining a reimbursement amount for healthcare services reimbursed under the input insurance product.

On the other hand, if the input insurance product is located as a result of the traversal of the reimbursement model data structure, a service group sub-hierarchy associated with the input insurance product in the reimbursement model may be identified. The product hierarchy traversal model 104 may then provide a root node 106 of the identified service group sub-hierarchy to the service group hierarchy traversal module 108. An illustrative method for traversing the product hierarchy of insurance products included in the reimbursement model will be described in more detail through reference to FIG. 6.

Upon receipt of the root node 106 of the identified service group sub-hierarchy, computer-executable instructions provided as part of the service group hierarchy traversal module 108 may be executed by the processor(s) 202 to analyze the identified service group sub-hierarchy to identify one or more service groups that include the healthcare services identified on the received healthcare claim. As a non-limiting example, the service groups included in the identified service group sub-hierarchy may be organized in a hierarchal data structure (e.g., a tree) that may be traversed to identify suitable service group(s) in accordance with which reimbursement amounts may be determined for the healthcare service(s) rendered to the patient. In certain embodiments, traversal of the service group sub-hierarchy may yield no suitable service group(s) for reimbursement amount determination, in which case, an exception message may be generated and communicated to a user of the reimbursement determination system 102 and/or one or more external systems.

In other embodiments, one or more service groups that are suitable for reimbursement amount determination may be identified. In certain embodiments, one or more criteria for reimbursement amount determination may be identified from the input data received by the reimbursement determination system 102. The service group hierarchy traversal module 108 may assess the identified criteria to identify one or more service groups that satisfy the criteria. The criteria may include, but are not limited to, whether the healthcare service(s) identified in the healthcare claim are included in a service group, whether a service group includes appropriate reimbursement model parameter(s) for determining a reimbursement amount for the type of healthcare service(s) identified in the healthcare claim and/or the circumstances in connection with which the service(s) were rendered (e.g., inpatient vs. outpatient), and so forth. For ease of explanation hereinafter, it will be assumed that a single service group is identified based on the analysis performed by the service group hierarchy traversal module 108. However, it should be appreciated that multiple service groups may be identified with each service group utilized to determine reimbursement amount(s) for one or more healthcare services identified in the received healthcare claim.

The service group identified by the processing performed by the service group hierarchy traversal module 108 may be provided as input to the model based evaluation module 112. The model based evaluation module 112 may include computer-executable instructions that responsive to execution by the processor(s) 202 cause model-based evaluation processing to be performed. The model-based evaluation processing may utilize one or more reimbursement model parameter(s) 214 associated with the identified service group to determine a first interim reimbursement amount 114 for one or more healthcare services. As previously noted, the reimbursement model parameter(s) 214 may include a reimbursement term parameter that specifies a basis on which reimbursement will be determined (e.g., per-diem, per test, per visit, etc.), a reimbursement type parameter that species a type of reimbursement (e.g., fixed dollar amount, percentage of billed charges, case rate, etc.), and/or a reimbursement tier parameter that specifies whether different reimbursement amounts may apply to different time periods over which the healthcare service(s) are rendered (e.g., a first reimbursement amount for a first X number of days of a hospital visit and a second reimbursement amount for a second Y number of days of the hospital visit), and so forth. In addition, one or more reimbursement model parameter(s) 214 may specify adjustments to be made to reimbursement amounts specified by other reimbursement model parameter(s) 214 (such as those described above) based on at least a portion of the input data received by the reimbursement determination system 102. For example, one or more reimbursement model parameter(s) 214 may indicate adjustments to be made to reimbursement amounts based on various incentives or disincentives negotiated between a healthcare provider and a payor (e.g., incentives or disincentives relating to the quality of care provided by the healthcare provider). It should be appreciated that the above-described reimbursement model parameter(s) 214 are merely illustrative and that numerous other types of reimbursement parameters are within the scope of the disclosure.

Upon determination of the first interim reimbursement amount 114, the first interim amount 114 may be provided as input to the rules based evaluation module 116. The rules based evaluation module 116 may include computer-executable instructions that responsive to execution by the processor(s) 202 cause reimbursement evaluation processing to be performed to determine a second interim reimbursement amount 118. The rules based evaluation module 116 may include computer-executable instructions for determining whether one or more reimbursement rules 216 are satisfied based on the input data received by the reimbursement determination system 102. Each such reimbursement rule 216 may specify a predicate condition and an adjustment function to be performed on the first interim reimbursement amount 114 if the predicate condition is determined to be satisfied. As a non-limiting example, a particular reimbursement rule 216 may specify that if the healthcare provider is a hospital, then 120% of the first interim reimbursement amount 114 should be calculated to determine the second interim reimbursement amount 118. As another non-limiting example, another reimbursement rule 216 may specify that if the healthcare provider is part of a specified provider network and the healthcare service(s) were rendered within a particular geographical area, then 130% of the first interim reimbursement amount 114 should be calculated to determine the second interim reimbursement amount 118. It should be appreciated that the above examples are merely illustrative and that numerous other types of reimbursement rule(s) 216 may be associated with a service group and assessed to determine the second interim reimbursement amount 118.

Upon determination of the second interim reimbursement amount 118, the rules-based evaluation module 116 may provide the amount to the payment recommendations evaluation module 120. The payment recommendations evaluation module 120 may include computer-executable instructions that responsive to execution by the processor(s) 202 causes evaluation processing to be performed to determine, based on payment recommendations data 134 received by the reimbursement determination system 102, whether the second interim reimbursement amount 118 should be modified to generate the final reimbursement amount 122, whether an alternate reimbursement amount determined by another system should be used in lieu of the second interim reimbursement amount 118 as the final reimbursement amount 122, or whether the second reimbursement amount 118 should be treated as the final reimbursement amount 122. For example, in certain embodiments, the payment recommendations data 134 may indicate one or more bases for modifying the second interim reimbursement amount 118 determined by the rules-based evaluation module 116 or for using an alternate reimbursement amount in lieu of the second reimbursement amount 118. In other embodiments, even after an evaluation of the payment recommendations data 134, the second interim reimbursement amount 118 may be determined to be the most appropriate for use as the final reimbursement amount 122.

In other embodiments, one or both of the first interim reimbursement amount 114 and the second interim reimbursement amount 118 may be determined by one or more systems external to the reimbursement determination system 102 and may be communicated to the reimbursement determination system 102 for use in determining a final reimbursement amount. In certain embodiments, external system(s) may be configured to perform processing based on variety of types of data that may be similar to at least a portion of the input data received by the reimbursement determination system 102 such as, for example, data relating to quality or performance metrics associated with healthcare providers, data relating to performance incentives and/or disincentives negotiated between payors and healthcare providers, and so forth. Information generated based on such processing may be communicated by the external system(s) to the reimbursement determination system 102 to determine, modify or validate an interim reimbursement rate (e.g., the first interim reimbursement rate 114 and/or the second interim reimbursement rate 118) generated as part of the reimbursement determination processing described herein. The information received from the external system(s) described above may, in certain embodiments, form at least part of the payment recommendations data 134 or may represent another type of input data received by the reimbursement determination system 102.

Those of ordinary skill in the art will appreciate that the reimbursement determination system 102 may include any number of alternate and/or additional hardware, software, or firmware components beyond those described or depicted without departing from the scope of the disclosure. More particularly, it should be appreciated that software, firmware, or hardware components depicted or described as forming part of the reimbursement determination system 102 and the reimbursement determination computer(s) 200, and the associated functionality that such components or sub-components included therein support, are merely illustrative and that some components may not be present or additional components may be provided in various embodiments. While various program modules have been depicted and described, it should be appreciated that the functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of the software, firmware, and/or hardware for implementing the functionality. Accordingly, it should be appreciated that the functionality described as being provided by a particular module may, in various embodiments, be provided, at least in part, by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

Those of ordinary skill in the art will appreciate that the illustrative abstracted reimbursement determination system 102 depicted in FIG. 1 and the more detailed depiction in FIG. 2 of reimbursement determination computer(s) 200 that may form part of the reimbursement determination system 102 are provided by way of example only. Numerous other operating environments, system architectures, and device configurations are within the scope of this disclosure. Other embodiments of the disclosure may include fewer or greater numbers of components and/or devices and may incorporate some or all of the functionality described herein, or additional functionality.

FIG. 3 is a schematic block diagram of an illustrative hierarchal relationship between insurance products associated with an illustrative reimbursement model in accordance with one or more embodiments of the disclosure.

As shown in FIG. 3, various insurance products may be organized into a hierarchal relationship within a reimbursement model. While an illustrative reimbursement model organized in accordance with a tree data structure is shown in FIG. 3, it should be appreciated that any suitable data structure or organizational paradigm may be used to specify the relationship between various entities forming part of the reimbursement model. In certain embodiments, an identifier associated with the reimbursement model may represent a root node 302 of the model. Various insurance products may be related as child nodes 304, 306 of the root node 302. Further, in certain embodiments, an insurance product node (e.g., node 304) may be a parent node to one or more child insurance product nodes (e.g., node 308). For example, the PPO Select Product 308 illustratively depicted in FIG. 3 may be a sub-product that is a specific type of PPO Product 304. Such a relationship between insurance products may be represented using a parent-child relationship.

In addition, the reimbursement model may include various service groups. The service groups may be represented as nodes within the reimbursement model. Each service group node (e.g., node 310, node 312, node 314, node 316, node 318) may be a child node of a respective corresponding parent insurance product node (e.g., node 306, node 308). Further, various service group nodes may be represented as child nodes of other service group nodes (e.g., the ICU service group node 314 is a child node of the parent Inpatient Service Group node 310). Various collections of reimbursement rule(s) (e.g., 304A, 308A) may be associated with insurance product nodes (e.g., node 304, node 308). In addition, various collections of reimbursement rule(s) (e.g., 310A, 312A, 314A, 316A, 318A) may be associated with respective corresponding service group nodes (e.g., node 310, node 312, node 314, node 316, node 318). Still further, various collections of reimbursement model parameter(s) (e.g., 310B, 312B, 314B, 316B, 318B) may be associated with respective corresponding service group nodes (e.g., node 310, node 312, node 314, node 316, node 318). In certain embodiments, each node in the reimbursement model may represent a class defined within an object-oriented paradigm, with each class including corresponding methods and variables (e.g., reimbursement rules(s) and reimbursement model parameter(s)). It should be appreciated that the organizational structure depicted in FIG. 3 is merely illustrative and that a reimbursement model may be organized in accordance with any suitable organizational structure.

FIG. 4 is a schematic block diagram of an illustrative reference hierarchal relationship between insurance products in accordance with one or more embodiments of the disclosure. As shown in FIG. 4, the reference hierarchal relationship may include a root node representative of all insurance products included in the hierarchy. In certain embodiments, such as for example in object-oriented paradigms, the root node of the reference hierarchal relationship may represent a superclass such as an abstract base class. Each product may then be represented within the hierarchy as a child node of either the root node or another parent node within the hierarchy. Any particular reimbursement model may not include all the node elements in the reference hierarchy; however, the ancestral relationship between nodes may be preserved. For example, a reimbursement model may include Sub-Product A-1 without including Product A. However, in such a scenario, Sub-Product A-1 may not be able to be made a child node of Product B.

### Illustrative Processes

FIG. 5 is a process flow diagram of an illustrative method 500 for determining an allowed reimbursement amount based on reimbursement model parameter(s) and reimbursement rule(s) associated with a reimbursement model in accordance with one or more embodiments of the disclosure. One or more operations of the illustrative method 500 may be performed, for example, by one or more of the program modules of the reimbursement determination application 210 executing on one or more reimbursement determination computers 200 of the reimbursement determination system 102.

At block 502, a reimbursement model may be identified. The reimbursement model may be identified based, for example, on an identifier associated with the reimbursement model that is included in the reimbursement model data 124 received by the reimbursement determination system 102.

At block 504, input data including healthcare claim data may be identified. The input data may include, for example, the insurance product data 126, the billed healthcare services data 128, the other healthcare claim data 130, the provider/contract/network/member data 132, and/or the payment recommendations data 134. In certain other embodiments, the input data may further include data identifying interim reimbursement amounts determined by external system(s) and/or data that may be used to determine, modify or validate interim reimbursement amounts and/or final reimbursement amounts determined by the reimbursement determination system 102. At least the insurance product data 126, the billed healthcare services data 128, and/or the other healthcare claim data 130 may form at least part of the healthcare claim data.

At block 506, an input insurance product may be identified from the input data. For example, the input insurance product may be identified from the insurance product data 126. The input insurance product may correspond to an insurance product offered by an insurer and held by a patient to whom healthcare service(s) associated with a received healthcare claim are rendered and according to which reimbursement amount determinations may be made.

At block 508, a product hierarchy of the identified reimbursement model may be traversed to determine whether the input insurance product is included within the reimbursement model. At block 510, a determination may be made that the input insurance product is associated with the reimbursement model based on the traversal of the product hierarchy of the reimbursement model. In those embodiments in which the input insurance product is determined not form part of the reimbursement model, one or more exception messages may be generated and presented to a user of the reimbursement determination system 102 and/or communicated to one or more external systems.

At block 512, a service group sub-hierarchy associated with the input insurance product may be identified. The service group sub-hierarchy may include, for example, those service groups that share a common parent service group node that is a child of the input insurance product node.

At block 514, the service group sub-hierarchy may be traversed in accordance with any suitable traversal methodology in order to identify one or more service groups that are appropriate for determining reimbursement amount(s) associated with one or more healthcare services identified in a received healthcare claim. In certain embodiments, multiple service group sub-hierarchies may be associated with the input insurance product. In such embodiments, each such service group hierarchy may be traversed to identify appropriate service group(s).

At block 516, one or more service groups may be identified based on at least a portion of the input data received by the reimbursement determination system 102. For ease of explanation, the remaining operations of the illustrative method 500 will be described in the context of a single service group being identified as suitable for reimbursement amount determination. In certain embodiments, one or more criteria may be identified based on at least a portion of the input data received (e.g., at least a portion of the healthcare claim data) and those service group(s) satisfying the identified criteria may be determined. As a non-limiting example, those service group(s) that include one or more healthcare services identified on the received healthcare claim may be identified. As a further non-limiting example, other identified criteria may be assessed based on reimbursement model parameters associated with service groups to determine which service group(s) may be suitable for reimbursement amount determination. In those embodiments in which no suitable service group is identified, one or more exception messages may be generated and presented to a user of the reimbursement determination system 102 and/or communicated to one or more external systems.

At block 518, a first interim reimbursement amount may be determined for one or more rendered healthcare services based on one or more reimbursement model parameters associated with the identified service group. The first interim reimbursement amount may be determined in accordance with any of the methodologies previously described and based on any of the illustrative reimbursement model parameter(s) described herein.

At block 520, a second interim reimbursement amount may be determined from the first interim reimbursement amount based on one or more reimbursement rule(s) associated with the identified service group. The second interim reimbursement amount may be determined in accordance with any of the methodologies previously described and based on any of the illustrative reimbursement rule(s) described herein. As previously noted, in other embodiments, data received from one or more external systems may be used to identify, determine, modify or validate interim reimbursement amounts.

At block 522, a final reimbursement amount may be determined based on the second interim reimbursement amount and/or payment recommendations data. More specifically, a determination may be made as to whether to adjust the second interim reimbursement amount based on payment recommendations data 134 received by the reimbursement determination system 102. The determination at block 522 may encompass a determination to adjust or otherwise modify the second interim reimbursement amount based on the payment recommendations data 134 to generate the final reimbursement amount, a determination to utilize a recommended reimbursement amount included in the payment recommendations data 134 as the final reimbursement amount in lieu of the second interim reimbursement amount, or a determination to ignore any recommendations provided in the payment recommendations data 134 and utilize the second interim reimbursement amount as the final reimbursement amount.

At block 524, the final reimbursement amount determined based on the prior operations of the illustrative method 500 may be communicated to one or more external systems and/or presented to a user of the reimbursement determination system 102 along with potentially other reimbursement information as described previously. For example, the final reimbursement amount may be communicated to a healthcare provider system, a payor system, a platform or gateway for aggregating healthcare claim data, and so forth.

FIG. 6 is a process flow diagram of an illustrative method 600 for identifying a service group sub-hierarchy associated with an input insurance product and a corresponding reimbursement model in accordance with one or more embodiments of the disclosure. One or more of the operations of the illustrative method 600 may be performed upon execution of computer-executable instructions provided as part of the product hierarchy traversal module 104.

At block 602, an input insurance product may be identified based, for example, on insurance product data 126 received by the reimbursement determination system 102. At block 604, a reimbursement model may be identified based, for example, on a reimbursement model identifier included in reimbursement model data 124 received by the reimbursement determination system 102.

At block 606, a product hierarchy associated with the reimbursement model may be traversed. In certain embodiments, the reimbursement model may be organized in accordance with a tree structure including parent and child insurance product nodes. The tree structure may be traversed in order to determine whether the input insurance product is included in the reimbursement model. However, it should be appreciated that the reimbursement model may be organized according to any suitable structure.

At block 608, a determination may be made as to whether the input insurance product is associated with the reimbursement model. The determination at block 608 may be a determination as to whether the input insurance product is represented as a node within the reimbursement model product hierarchy.

If it is determined at block 608, that the input insurance product is included in the reimbursement model, the method 600 may proceed to block 610 where a root of a service group sub-hierarchy associated with the input insurance product may be identified. On the other hand, if it is determined at block 608 that the input insurance product is not associated with the reimbursement model, the method 600 may proceed to block 612.

At block 612, an ancestor insurance product of the input insurance product may be identified based on a reference product hierarchy that may serve as a template for the reimbursement model. At block 614, a determination may be made as to whether the ancestor insurance product is associated with the reimbursement model. If it is determined at block 614 that the ancestor insurance product is associated with the reimbursement model, the method 600 may proceed to block 616 where a root of the service group hierarchy associated with the ancestor insurance product may be identified.

On the other hand, if it is determined at block 614 that the ancestor insurance product is not associated with the reimbursement model, the method 600 may proceed to block 618. At block 618, a determination may be made that an allowed reimbursement amount cannot be generated or determined in accordance with the identified reimbursement model. In certain embodiments, an exception message may be generated and communicated to one or more entities subsequent to the determination at block 618. Additionally, or alternatively, an alternative reimbursement model may be identified and the product hierarchy associated with that alternative reimbursement model may be identified and traversed to determine whether the input insurance product is associated therewith. Further, in certain embodiments, the operations of 614-618 may be performed iteratively until an assessment has been made with respect to all ancestor insurance products of the input insurance product as to whether any such ancestor insurance product is associated with the reimbursement model. In various embodiments, once a root node of a service group sub-hierarchy is identified such as, for example, at block 610 or 616, the root node may be provided to the service group hierarchy traversal module 108 to determine whether any one or more service groups within the sub-hierarchy are suitable for reimbursement amount determination.

FIG. 7 is a process flow diagram of an illustrative method 700 for identifying one or more service groups in accordance with which model-based and/or rule-based processing may be performed to determine an allowed reimbursement amount in accordance with one or more embodiments of the disclosure. One or more of the operations of the illustrative method 700 may be performed upon execution of computer-executable instructions provided as part of, for example, the service group hierarchy traversal module 108.

At block 702, an indication of a root node of an identified service group sub-hierarchy may be received by the service group hierarchy traversal module 108 from the product hierarchy traversal module 104. At block 704, the service group sub-hierarchy may be traversed in accordance with one or more traversal methodologies.

At block 706, a determination may be made as to whether traversal of the service group sub-hierarchy is complete. Traversal may be completed when all service group nodes in the sub-hierarchy have been visited by the traversal. If it is determined at block 706 that the traversal is complete and that no suitable service group has been identified, the method 700 may proceed to block 708 where a determination may be made that an allowed reimbursement amount cannot be determined in accordance with the identified reimbursement model.

On the other hand, if it is determined at block 706 that the traversal is not complete, the method 700 may proceed to block 710 and a previously un-traversed service group may be selected for evaluation. At block 712, a determination may be made as to whether the selected service group is appropriate for use in determining an allowed reimbursement for one or more healthcare services identified on a received healthcare claim. The determination at block 712 may be made in accordance with any of the methodologies described previously.

If it is determined at block 712 that the selected service group is not suitable for use in determining an allowed reimbursement amount, the method 700 may again proceed to block 706 where a determination may be made as to whether the traversal of the sub-hierarchy is complete. If, on the other hand, it is determined at block 712 that the selected service group is suitable for use in determining an allowed reimbursement amount, the method 700 may proceed to block 714 where model-based and/or rules-based processing may be performed to determine the allowed reimbursement amount in accordance with any of the techniques or methodologies described herein. The operations 706-714 may represent an iterative process that tracks the traversal of the service group sub-hierarchy through each of the service nodes included therein.

The operations described and depicted in the illustrative methods 500, 600, and 700 of FIGS. 5-7 may be carried out or performed in any suitable order as desired in various embodiments of the disclosure. Additionally, in certain embodiments, at least a portion of the operations may be carried out in parallel. Furthermore, in certain embodiments, less, more, or different operations than those depicted in FIGS. 5-7 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described for performing filtering and/or selection processing in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method, comprising:
identifying, by a reimbursement determination system comprising one or more computers, a reimbursement model;
receiving, by the reimbursement determination system, input data comprising healthcare claim data associated with a healthcare claim, wherein the healthcare claim data comprises data identifying an insurance product offered by a payor and associated with a patient and data identifying a healthcare service rendered to the patient;
determining, by the reimbursement determination system, that the insurance product is associated with the reimbursement model;
determining, by the reimbursement determination system and based at least in part on the reimbursement model, a group of healthcare services associated with the insurance product, wherein the group of healthcare services comprises the healthcare service rendered to the patient;
identifying, by the reimbursement determination system, at least one of: i) a set of one or more reimbursement model parameters associated with the group of healthcare services or ii) a set of one or more reimbursement rules associated with the group of healthcare services; and
determining, by the reimbursement determination system and based at least in part on at least one of: i) the set of one or more reimbursement model parameters or ii) the set of one or more reimbursement rules, a reimbursement amount for the healthcare service rendered to the patient.

2. The method of claim 1, wherein the set of one or more reimbursement model parameters and the set of one or more reimbursement rules are identified, and wherein determining the reimbursement amount comprises:
determining, by the reimbursement determination system, a first interim reimbursement amount for the healthcare service rendered to the patient based at least in part on the set of one or more reimbursement model parameters;
determining, by the reimbursement determination system, a second interim reimbursement amount for the healthcare service rendered to the patient based at least in part on application of the set of one or more reimbursement rules to the first interim reimbursement amount; and
determining, by the reimbursement determination system, the reimbursement amount for the healthcare service rendered to the patient based at least in part on the second interim reimbursement amount.

3. The method of claim 2, further comprising:
receiving, by the reimbursement determination system, payment recommendations data,
wherein the reimbursement amount is determined further based at least in part on the payment recommendations data.

4. The method of claim 3, further comprising:
adjusting, by the reimbursement determination system, the second interim reimbursement amount based at least in part on the payment recommendations data to generate an adjusted reimbursement amount,
wherein the reimbursement amount is the adjusted reimbursement amount.

5. The method of claim 3, further comprising:
identifying, by the reimbursement determination system, a recommended reimbursement amount from the payment recommendations data, wherein the recommended reimbursement amount is different from the second interim reimbursement amount;
determining, by the reimbursement determination system, that the reimbursement amount is the recommended reimbursement amount.

6. The method of claim 2, wherein the set of one or more reimbursement model parameters comprise at least one of:
i) a reimbursement term parameter,
ii) a reimbursement type parameter,
iii) a reimbursement tier parameter,
iv) a reimbursement fee schedule, or
v) a reimbursement parameter based at least in part on the input data.

7. The method of claim 2, wherein application of the set of one or more reimbursement rules to the first interim reimbursement amount comprises:
determining, by the reimbursement determination system, that the healthcare claim data satisfies a respective predicate condition associated with at least one reimbursement rule of the set of one or more reimbursement rules; and
applying, by the reimbursement determination system and based at least in part on determining that the healthcare claim data satisfies the respective predicate condition, a respective function associated with the at least one reimbursement rule to the first interim reimbursement amount to determine the second interim reimbursement amount.

8. The method of claim 1, wherein the reimbursement model corresponds to a negotiated fee arrangement between the payor and a healthcare provider that rendered the healthcare service to the patient.

9. The method of claim 1, further comprising:
traversing, by the reimbursement determination system, a product hierarchy associated with the reimbursement model; and
identifying, by the reimbursement determination system, the insurance product in the product hierarchy based at least in part on the traversing,
wherein the insurance product is determined to be associated with the reimbursement model based at least in part on identifying the insurance product in the product hierarchy.

10. The method of claim 1, wherein determining a group of healthcare services associated with the insurance product comprises:
determining, by the reimbursement determination system, a service group sub-hierarchy within the reimbursement model, wherein the service group sub-hierarchy is associated with the insurance product;
traversing, by the reimbursement determination system, the service group sub-hierarchy to identify the group of healthcare services associated with the insurance product;
identifying, by the reimbursement determination system, one or more reimbursement criteria based at least in part on at least a portion of the healthcare claim data; and
determining, by the reimbursement determination system, that one or more attributes associated with the group of healthcare services satisfy the one or more reimbursement criteria.

11. The method of claim 1, wherein the input data further comprises:
i) data indicating one or more quality metrics associated with the healthcare provider;
ii) data indicating one or more incentives or disincentives negotiated between the payor and the healthcare provider, or
iii) data indicating a disease state or disease trend associated with the patient or a demographic population comprising the patient.

12. The method of claim 1, wherein the healthcare claim data is first healthcare claim data, the healthcare claim is a first healthcare claim, the insurance product is a first insurance product, the patient is a first patient, and the healthcare service is a first healthcare service, and wherein the input data comprises second healthcare claim data associated with a second healthcare claim, the second healthcare claim data comprising data identifying a second insurance product offered by the payor and associated with a second patient and data identifying a second healthcare service rendered to the second patient, the method further comprising:
determining, by the reimbursement determination system, that a reimbursement amount associated with the second healthcare service cannot be determined;
generating, by the reimbursement determination system, an exception message indicating that the reimbursement amount associated with the second healthcare service cannot be determined; and
communicating, by the reimbursement determination system, the exception message to one or more external systems.

13. The method of claim 12, wherein determining that the reimbursement amount associated with the second healthcare service cannot be determined comprises one of:
determining, by the reimbursement determination system, that the second insurance product is not associated with the reimbursement model, or
determining, by the reimbursement determination system, that the reimbursement model is not associated with a group of services that includes the second healthcare service.

14. The method of claim 1, further comprising at least one of:
presenting, by the reimbursement determination system to a user of the reimbursement determination system, reimbursement information comprising: i) an indication of the reimbursement amount and ii) audit information associated with determination of the reimbursement amount, or
transmitting, by the reimbursement determination system, the reimbursement information to one or more other systems.

15. A system, comprising:
at least one processor; and
at least one memory storing computer-executable instructions,
wherein the at least one processor is configured to access the at least one memory and execute the computer-executable instructions to:
identify a reimbursement model;
receive input data comprising healthcare claim data associated with a healthcare claim, wherein the healthcare claim data comprises data identifying an insurance product offered by a payor and associated with a patient and data identifying a healthcare service rendered to the patient;
determine that the insurance product is associated with the reimbursement model;
determine, based at least in part on the reimbursement model, a group of healthcare services associated with the insurance product, wherein the group of healthcare services comprises the healthcare service rendered to the patient;
identify at least one of: i) a set of one or more reimbursement model parameters associated with the group of healthcare services or ii) a set of one or more reimbursement rules associated with the group of healthcare services; and
determine, based at least in part on at least one of: i) the set of one or more reimbursement model parameters or ii) the set of one or more reimbursement rules, a reimbursement amount for the healthcare service rendered to the patient.

16. The system of claim 15, wherein the set of one or more reimbursement model parameters and the set of one or more reimbursement rules are identified, and wherein, to determine the reimbursement amount, the at least one processor is further configured to execute the computer-executable instructions to:
determine a first interim reimbursement amount for the healthcare service rendered to the patient based at least in part on the set of one or more reimbursement model parameters;
apply at least one reimbursement rule of the set of one or more reimbursement rules to the first interim reimbursement amount to determine a second interim reimbursement amount for the healthcare service rendered to the patient; and
determine the reimbursement amount for the healthcare service rendered to the patient based at least in part on the second interim reimbursement amount.

17. The system of claim 16, wherein the at least one processor is further configured to execute the computer-executable instructions to:
receive payment recommendations data,
wherein, to determine the reimbursement amount, the at least one processor is further configured to execute the computer-executable instructions to:
determine the reimbursement amount further based at least in part on the payment recommendations data.

18. The system of claim 17, wherein the at least one processor is further configured to execute the computer-executable instructions to:
adjust the second interim reimbursement amount based at least in part on the payment recommendations data to generate an adjusted reimbursement amount,
wherein the reimbursement amount is the adjusted reimbursement amount.

19. The system of claim 17, wherein the at least one processor is further configured to execute the computer-executable instructions to:
identify a recommended reimbursement amount from the payment recommendations data, wherein the recommended reimbursement amount is different from the second interim reimbursement amount;
determine that the reimbursement amount is the recommended reimbursement amount.

20. The system of claim 16, wherein the set of one or more reimbursement model parameters comprise at least one of:
i) a reimbursement term parameter,
ii) a reimbursement type parameter,
iii) a reimbursement tier parameter,
iv) a reimbursement fee schedule, or
v) a reimbursement parameter based at least in part on the input data.

21. The system of claim 16, wherein, to apply at least one reimbursement rule of the set of one or more reimbursement rules to the first interim reimbursement amount, the at least one processor is further configured to execute the computer-executable instructions to:
determine that the healthcare claim data satisfies a respective predicate condition associated with the at least one reimbursement rule of the set of one or more reimbursement rules; and
apply, based at least in part on a determination that the healthcare claim data satisfies the respective predicate condition, a respective function associated with the at least one reimbursement rule to the first interim reimbursement amount to determine the second interim reimbursement amount.

22. The system of claim 15, wherein the at least one processor is further configured to execute the computer-executable instructions to:
traverse a product hierarchy associated with the reimbursement model; and
identify the insurance product in the product hierarchy based at least in part on the traversal,
wherein the at least one processor is configured to determine that the insurance product is determined associated with the reimbursement model based at least in part on identifying the insurance product in the product hierarchy.

23. The system of claim 15, wherein, to determine a group of healthcare services associated with the insurance product, the at least one processor is further configured to execute the computer-executable instructions to:
determine a service group sub-hierarchy within the reimbursement model, wherein the service group sub-hierarchy is associated with the insurance product;
traverse the service group sub-hierarchy to identify the group of healthcare services associated with the insurance product;
identify one or more reimbursement criteria based at least in part on at least a portion of the healthcare claim data; and
determine that one or more attributes associated with the group of healthcare services satisfy the one or more reimbursement criteria.

24. The system of claim 15, wherein the healthcare claim data is first healthcare claim data, the healthcare claim is a first healthcare claim, the insurance product is a first insurance product, the patient is a first patient, and the healthcare service is a first healthcare service, wherein the input data comprises second healthcare claim data associated with a second healthcare claim, the second healthcare claim data comprising data identifying a second insurance product offered by the payor and associated with a second patient and data identifying a second healthcare service rendered to the second patient, and wherein the at least on processor is further configured to execute the computer-executable instructions to:
determine that a reimbursement amount associated with the second healthcare service cannot be determined;
generate an exception message indicating that the reimbursement amount associated with the second healthcare service cannot be determined; and
communicate the exception message to one or more external systems.

25. The system of claim 15, wherein, to determine that the reimbursement amount associated with the second healthcare service cannot be determined, the at least one processor is configured to execute the computer-executable instructions to one of:
determine that the second insurance product is not associated with the reimbursement model, or
determine that the reimbursement model is not associated with a group of services that includes the second healthcare service.

26. The system of claim 15, wherein the at least one processor is further configured to execute the computer-executable instructions to:
receive information from one or more external systems indicative of one or more interim reimbursement amounts; and
determine the reimbursement amount based at least in part on the one or more interim reimbursement amounts.

27. One or more computer-readable media storing computer-executable instructions that responsive to execution cause operations to be performed comprising:
identifying a reimbursement model;
receiving input data comprising healthcare claim data associated with a healthcare claim, wherein the healthcare claim data comprises data identifying an insurance product offered by a payor and associated with a patient and data identifying a healthcare service rendered to the patient;
determining that the insurance product is associated with the reimbursement model;
determining, based at least in part on the reimbursement model, a group of healthcare services associated with the insurance product, wherein the group of healthcare services comprises the healthcare service rendered to the patient;
identifying at least one of: i) a set of one or more reimbursement model parameters associated with the group of healthcare services or ii) a set of one or more reimbursement rules associated with the group of healthcare services; and
determining, based at least in part on at least one of: i) the set of one or more reimbursement model parameters or ii) the set of one or more reimbursement rules, a reimbursement amount for the healthcare service rendered to the patient.
